(19) United States
(12) Patent Application Publication
(10) Pub. No.: US 2025/0300483 A1
(43) Pub. Date: Sep. 25, 2025

(54) CHARGING DEVICE AND CHARGING METHOD

(71) Applicant: Panasonic Automotive Systems Co., Ltd., Kanagawa (JP)

(72) Inventors: Naoya IWASAKI, Kanagawa (JP); Yuji KODERA, Osaka (JP); Shinichiro KOKUBO, Kanagawa (JP)

(21) Appl. No.: 19/051,972

(22) Filed: Feb. 12, 2025

(30) Foreign Application Priority Data
Mar. 21, 2024 (JP) 2024-045429

(51) Int. Cl. H02J 7/06

(52) U.S. Cl. CPC H02J 7/06

(57) ABSTRACT

A charging device according to the present disclosure include first to third input nodes, first to third switching element groups, first to third inductive elements, and a controller. The first to third switching element groups correspond to the first to third input nodes. The first to third inductive element is connected between the first input node and the first switching element group. The second inductive element is connected between the second input node and the second switching element group. The third inductive element is connected between the third input node and the third switching element group. The controller is configured to control the first to third switching element groups according to vector control using a first phase power and a second phase power when receiving the first phase power at the first input node and receiving the second phase power at the second input node.

### CROSS-REFERENCE TO RELATED APPLICATIONS

This application is based upon and claims the benefit of priority from Japanese Patent Application No. 2024-045429, filed Mar. 21, 2024, the entire contents of which are incorporated herein by reference.

### FIELD

The present disclosure relates to a charging device and a charging method.

### BACKGROUND

A charging device connected between an AC power supply and a battery converts AC power received from the AC power supply into DC power, and charges the battery with the DC power.

A related technique is described in JP 7280796 B2.

The charging device is desired to efficiently convert AC power into DC power.

The present disclosure provides a charging device and a charging method capable of efficiently converting AC power into DC power.

### SUMMARY

A charging device according to the present disclosure include a first input node, a second input node, a third input node, a first switching element group, a second switching element group, a third switching element group, a first inductive element, a second inductive element, a third inductive element, and a controller. The first switching element group corresponds to the first input node. The second switching element group corresponds to the second input node. The third switching element group corresponds to the third input node. The first inductive element is connected between the first input node and the first switching element group. The second inductive element is connected between the second input node and the second switching element group. The third inductive element is connected between the third input node and the third switching element group. The controller is configured to control the first switching element group, the second switching element group, and the third switching element group according to vector control using a first phase power and a second phase power when receiving the first phase power at the first input node and receiving the second phase power at the second input node.

### BRIEF DESCRIPTION OF THE DRAWINGS

FIG. 1 is a diagram illustrating a configuration of a charging device according to an embodiment;

FIG. 2 is a diagram illustrating a change in a connection configuration at the time of disconnection of the charging device according to the embodiment;

FIG. 3 is a diagram illustrating a configuration of a controller according to the embodiment;

FIG. 4 is a waveform diagram illustrating an operation of the controller according to the embodiment;

FIG. 5 is a diagram illustrating a configuration of a controller in a first modification of the embodiment;

FIG. 6 is a diagram illustrating a configuration of a controller in a second modification of the embodiment;

FIG. 7 is a diagram illustrating a configuration of a charging device according to a third modification of the embodiment;

FIG. 8 is a diagram illustrating a change in a connection configuration at the time of disconnection of the charging device according to the third modification of the embodiment; and

FIG. 9 is a waveform chart illustrating an operation of the charging device according to the third modification of the embodiment.

### DETAILED DESCRIPTION

Hereinafter, an embodiment of a charging device according to the present disclosure will be described with reference to the drawings.

### Embodiment

The charging device according to the embodiment is connected between an AC power supply and a battery, converts AC power received from the AC power supply into DC power, and charges the battery with the DC power, but is devised for efficiently converting the AC power into DC power.

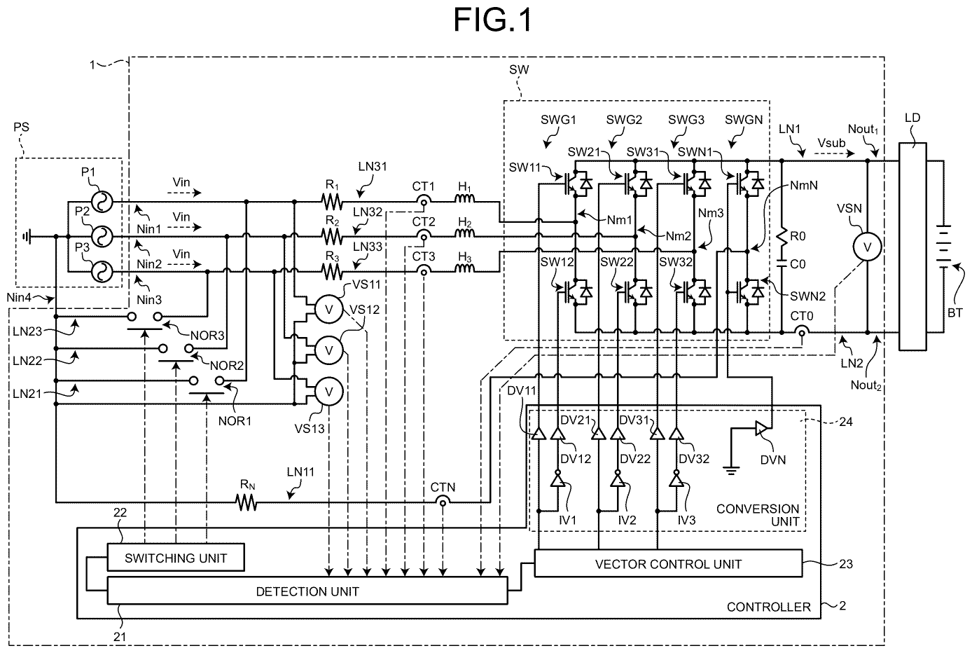

A charging device 1 can be configured as illustrated in FIG. 1. FIG. 1 is a diagram illustrating a configuration of the charging device 1.

The charging device 1 is electrically connected between an AC power supply PS and a battery BT. The charging device 1 can be connected to the battery BT via the load circuit LD. The charging device 1 converts an AC voltage Vin from the AC power supply PS into DC power including a DC voltage Vsub while boosting the AC voltage Vin, and supplies the converted DC power to the battery BT via the load circuit LD. Thus, the battery BT is charged. For example, the charging device 1 may include an in-vehicle charger mounted on an electric vehicle or a hybrid vehicle. The AC power supply PS may be a power system in a charging stand. The load circuit LD may include a DC-DC converter, and may further include a DC filter. The battery BT may include an in-vehicle battery.

The AC power supply PS may generate three-phase AC power or single-phase AC power. The charging device 1 may convert the three-phase AC power into the DC voltage Vsub, or may convert the single-phase AC power into the DC voltage Vsub. The three phases are referred to as a phase L1, a phase L2, and a phase L3. A ground line LN11 is also referred to as a line LN11 of the phase N.

Hereinafter, a case where the AC power supply PS generates three-phase AC power and the charging device 1 converts the three-phase AC power into the DC voltage Vsub will be exemplified. The AC power supply PS may include a power supply P1, a power supply P2, and a power supply P3. The power supply P1 generates power of the phase L1. The power supply P2 generates power of the phase L2. The power supply P3 generates power of the phase L3.

The charging device 1 includes a plurality of input nodes Nin1 to Nin4 and a plurality of output nodes Nout1 to Nout2. The input node Nin1 is connected to the power supply P1 and receives the power of the phase L1. The power of the phase L1 includes a voltage V_{L1} of the phase L1 and a current IL of the phase L1. The input node Nin2 is connected to the power supply P2 and receives power of the phase L2. The power of the phase L2 includes a voltage V_{L2} of the phase L2 and a current I_{L2} of the phase L2. The input node Nin3 is connected to the power supply P3 and receives power of the phase L3. The power of the phase L3 includes a voltage V_{L3} of the phase L3 and a current I_{L3} of the phase L3. The input node Nin4 is connected to the reference potential (for example, the ground potential).

The charging device 1 uses a power factor correction (PFC) circuit to convert AC power into DC power while improving the power factor of the AC power.

The charging device 1 includes, for example, as a PFC circuit, a switching circuit SW, an inductive element H1, an inductive element H2, an inductive element H3, resistive elements R0, R1, R2, R3, and RN, a capacitive element CO, voltage detectors VS11, VS12, VS13, and VSN, current detectors CT0, CT1, CT2, CT3, and CTN, relays NOR1, NOR2, and NOR3, and a controller 2. The switching circuit SW includes a switching element group SWG1, a switching element group SWG2, a switching element group SWG3, and a switching element group SWGN.

The controller 2 integrally controls each unit of the charging device 1.

In the charging device 1, under the control of the controller 2, the energy is repeatedly stored and released in the inductive elements H1, H2, and H3 by the switching operation of the switching element groups SWG1, SWG2, and SWG3, and accordingly, the current is repeatedly stopped and injected into the capacitive element CO. As a result, the charging device 1 can improve the power factor.

The charging device 1 may include a totem pole type configuration. The switching element group SWG1, the switching element group SWG2, the switching element group SWG3, and the switching element group SWGN are connected in parallel between a positive line LN1 and a negative line LN2. A plurality of switching elements SW can be connected in cascade connection to each switching element group SWG.

The switching element group SWG1 corresponds to the input node Nin1 and corresponds to the phase L1. The switching element group SWG1 can receive power of the phase L1. The switching element group SWG1 performs a switching operation under the control of the controller 2. As a result, an added voltage ΔV_{L1} and an added current ΔI_{L1} of the phase L1 are generated.

In the switching element group SWG1, an intermediate node Nm1 is electrically connected to the input node Nin1 via the line LN31.

The switching element group SWG1 includes a switching element SW11 and a switching element SW12. The switching element SW11 has one end connected to the positive line LN1, the other end connected to the intermediate node Nm1, and a control terminal connected to the controller 2. The switching element SW12 has one end connected to the intermediate node Nm1, the other end connected to the negative line LN2, and a control terminal connected to the controller 2.

The switching element group SWG2 corresponds to the input node Nin2 and corresponds to the phase L2. The switching element group SWG2 can receive power of the phase L2. The switching element group SWG2 performs a switching operation under the control of the controller 2. As a result, an added voltage ΔV_{L2} and an added current ΔI_{L2} of the phase L2 are generated.

In the switching element group SWG2, the intermediate node Nm2 is electrically connected to the input node Nin2 via the line LN32.

The switching element group SWG2 includes a switching element SW21 and a switching element SW22. The switching element SW21 has one end connected to the positive line LN1, the other end connected to the intermediate node Nm2, and a control terminal connected to the controller 2. The switching element SW22 has one end connected to the intermediate node Nm2, the other end connected to the negative line LN2, and a control terminal connected to the controller 2.

The switching element group SWG3 corresponds to the input node Nin3 and corresponds to the phase L3. The switching element group SWG3 can receive the power of the phase L3. The switching element group SWG3 performs a switching operation under the control of the controller 2. As a result, an added voltage ΔV_{L3} and an added current ΔI_{L3} of the phase L3 are generated.

In the switching element group SWG3, an intermediate node Nm3 is electrically connected to the input node Nin3 via the line LN33.

The switching element group SWG3 includes a switching element SW31 and a switching element SW32. The switching element SW31 has one end connected to the positive line LN1, the other end connected to the intermediate node Nm3, and a control terminal connected to the controller 2. The switching element SW32 has one end connected to the intermediate node Nm3, the other end connected to the negative line LN2, and a control terminal connected to the controller 2.

The switching element group SWGN corresponds to the phase N. In the switching element group SWGN, an intermediate node NmN is electrically connected to the input node Nin4 via the line LN11. The resistive element RN may be electrically inserted into the line LN11.

The switching element group SWGN includes a switching element SWN1 and a switching element SWN2. The switching element SWN1 has one end connected to the positive line LN1, the other end connected to the intermediate node NmN, and a control terminal connected to the controller 2. The switching element SWN2 has one end connected to the intermediate node NmN, the other end connected to the negative line LN2, and a control terminal connected to the controller 2.

In the switching circuit SW, a configuration including the switching element SW11, the switching element SW21, the switching element SW31, and the switching element SWN1 may be referred to as an upper arm, and a configuration including the switching element SW12, the switching element SW22, the switching element SW32, and the switching element SWN2 may be referred to as a lower arm.

The inductive element H1 is inserted into the line LN31 and electrically connected between the input node Nin1 and the switching element group SWG1. The inductive element H1 corresponds to the phase L1. The inductive element H1 is, for example, a coil, and has one end connected to the input node Nin1 and the other end connected to the switching element group SWG1. The inductive element H1 can contribute to improvement of the power factor of the charging device 1 by storing and releasing electromagnetic energy. The resistive element R1 may be inserted into the line LN31 and connected in series with the inductive element H1.

The inductive element H2 is inserted into the line LN32 and electrically connected between the input node Nin2 and the switching element group SWG2. The inductive element H2 corresponds to the phase L2. The inductive element H2 is, for example, a coil, and has one end connected to the input node Nin2 and the other end connected to the switching element group SWG2. The inductive element H2 can contribute to improvement of the power factor of the charging device 1 by storing and releasing electromagnetic energy. The resistive element R2 may be inserted into the line LN32 and connected in series with the inductive element H2.

The inductive element H3 is inserted into the line LN33 and electrically connected between the input node Nin3 and the switching element group SWG3. The inductive element H3 corresponds to the phase L3. The inductive element H3 is, for example, a coil, and has one end connected to the input node Nin3 and the other end connected to the switching element group SWG3. The inductive element H3 can contribute to improvement of the power factor of the charging device 1 by storing and releasing electromagnetic energy. The resistive element R3 may be inserted into the line LN33 and connected in series with the inductive element H3.

The capacitive element CO may be connected between the line LN1 and the line LN2. The capacitive element CO has one end electrically connected to the line LN1 and the other end electrically connected to the line LN2. A resistive element R0 may be connected in series with the capacitive element CO between the line LN1 and the line LN2.

The voltage detector VS11 has one end connected to the line LN31 and the other end connected to the reference potential (for example, the ground potential). The voltage detector VS11 can detect the voltage Vui of the phase L1.

The voltage detector VS12 has one end connected to the line LN32 and the other end connected to the reference potential (for example, the ground potential). The voltage detector VS12 can detect the voltage V_{L2} of the phase L2.

The voltage detector VS13 has one end connected to the line LN33 and the other end connected to the reference potential (for example, the ground potential). The voltage detector VS13 can detect the voltage VL3 of the phase L3.

The voltage detector VSN has one end connected to the output node Nout1 and the other end connected to the output node Nout2. The voltage detector VSN can detect the bus voltage V_{VSN}. The bus voltage V_{VSN} is an output DC voltage from the charging device 1 to the load circuit LD.

The current detector CT0 is disposed near the negative line LN2. The current detector CT0 detects the bus current I_{CT0} flowing through the negative line LN2. The bus current I_{CT0} is an output current from the charging device 1 to the load circuit LD.

The current detector CT1 is disposed near the line LN31. The current detector CT1 detects the current ILI in the phase L1 flowing through the line LN31.

The current detector CT2 is disposed near the line LN32. The current detector CT2 detects the current IL2 in the phase L2 flowing through the line LN32.

The current detector CT3 is disposed near the line LN33. The current detector CT3 detects the current IL3 in the phase L3 flowing through the line LN33.

The current detector CTN is disposed near the line LN11. The current detector CTN detects the current IIN in the phase LN flowing through the line LN11.

The relay NORI is inserted into the line LN31 and the line LN21 which the line LN11 can be connected. The relay NOR1 corresponds to the phase L1. The relay NOR1 has one end connected to the line LN31, the other end connected to the line LN11, and a control terminal connected to the controller 2. The relay NOR1 is a normally open relay. The relay NOR1 is in an OFF state in a normal state, and electrically disconnects the line LN31 from the line LN11. As a result, the current I_{L1} in the phase L1 can be supplied to the inductive element H1 side. The relay NOR1 can shift to an ON state under the control of the controller 2. The relay NOR1 can bypass the line LN31 to the line LN11 by being maintained in the ON state under the control of the controller 2. The relay NOR1 is released from the ON state and returned to the OFF state according to the control by the controller 2, so that the line LN31 is electrically disconnected from the line LN11 again. As a result, the state in which the current I_{L1} in the phase L1 can be supplied to the inductive element H1 side is restored.

The relay NOR2 is inserted into the line LN32 and the line LN22 which the line LN11 can be connected. The relay NOR2 corresponds to the phase L2. The relay NOR2 has one end connected to the line LN32, the other end connected to the line LN12, and a control terminal connected to the controller 2. The relay NOR2 is a normally open relay. The relay NOR2 is in the OFF state in a normal state, and electrically disconnects the line LN32 from the line LN12. As a result, the current IL2 in the phase L2 can be supplied to the inductive element H2 side. The relay NOR2 can shift to the ON state under the control of the controller 2. The relay NOR2 can bypass the line LN32 to the line LN12 by being maintained in the ON state under the control of the controller 2. The relay NOR2 is released from the ON state and returned to the OFF state according to the control by the controller 2, so that the line LN32 is electrically disconnected from the line LN12 again. As a result, the state in which the current I_{L2} in the phase L2 can be supplied to the inductive element H2 side is restored.

The relay NOR3 is inserted into the line LN33 and the line LN23 which the line LN11 can be connected. The relay NOR3 corresponds to the phase L3. The relay NOR3 has one end connected to the line LN33, the other end connected to the line LN13, and a control terminal connected to the controller 2. The relay NOR3 is a normally open relay. The relay NOR3 is in the OFF state in a normal state, and electrically disconnects the line LN33 from the line LN13. As a result, the current I_{L3} in the phase L3 can be supplied to the inductive element H3 side. The relay NOR3 can shift to the ON state under the control of the controller 2. The relay NOR3 can bypass the line LN33 to the line LN13 by being maintained in the ON state under the control of the controller 2. The relay NOR3 is released from the ON state and returned to the OFF state according to the control by the controller 2, so that the line LN33 is electrically disconnected from the line LN13 again. As a result, the state in which the current I_{L3} in the phase L3 can be supplied to the inductive element H3 side is restored.

In the charging device 1, one of the three phases (phases L1, L2, and L3) may become unusable due to disconnection or the like. In this case, the controller 2 selectively shifts the relay NOR corresponding to the unusable single phase to the ON state and connects the inductive element H of the line LN of the single phase to the line LN11 by bypass connection, and causes the line LN of the two phases usable to supply the power of two phases to the switching circuit SW. The controller 2 controls the switching element group SWG1, the switching element group SWG2, and the switching element group SWG3 in the switching circuit SW according to vector control using the power of two phases while causing the inductive elements H corresponding to the two phases to store and release electromagnetic energy.

At this time, it is the power of two phases usable that is supplied to the switching circuit SW, but since the inductive element H of unusable single phase is bypass-connected to the line LN11, a three-phase voltage can be generated by the switching operation of the switching element group SWG of the three phases. As a result, the output DC voltage V_{VSN} can be stably generated as an addition result of the three-phase voltages.

The usable two phases are referred to as a first phase and a second phase. The controller 2 controls a voltage vector corresponding to the first phase power and the second phase power. The controller 2 controls the switching element group SWG1, the switching element group SWG2, and the switching element group SWG3 using a first control voltage, a second control voltage, and a third control voltage according to the adjusted voltage vector.

The controller 2 converts a first phase current according to the first phase power, a second phase current according to the second phase power, and a third phase current according to the third phase power into a d-axis current and a q-axis current. The controller 2 converts a d-axis command voltage according to a first target value of the d-axis current and a q-axis command voltage according to a second target value of the q-axis current into a first control voltage, a second control voltage, and a third control voltage. The first target value of the d-axis current may be substantially zero. The second target value of the q-axis current can be determined according to the amount of current to flow into the capacitive element CO. The controller 2 controls the switching element group SWG1, the switching element group SWG2, and the switching element group SWG3 using the first control voltage, the second control voltage, and the third control voltage.

The controller 2 includes a detection unit 21, a switching unit 22, a vector control unit 23, and a conversion unit 24. The detection unit 21 receives voltage detection values of the voltage detectors VS11, VS12, VS13, and VSN, and receives current detection values of the current detectors CT0, CT1, CT2, and CT3.

The detection unit 21 detects that one of the three phases (phases L1, L2, and L3) cannot be used due to disconnection or the like according to the voltage detection value of the voltage detector VS and the current detection value of the current detector CT. The detection unit 21 supplies the detection results to the switching unit 22 and the vector control unit 23.

When receiving the detection result indicating the unusable single phase from the detection unit 21, the switching unit 22 selectively shifts the relay NOR corresponding to the unusable single phase to the ON state and connects the inductive element H of the line LN of the single phase to the line LN11 by bypass connection.

When receiving the detection result indicating the unusable single phase from the detection unit 21, the vector control unit 23 performs vector control using the power of two phases usable, generates the first control voltage, the second control voltage, and the third control voltage, and supplies the first control voltage, the second control voltage, and the third control voltage to the conversion unit 24.

When receiving the first control voltage, the second control voltage, and the third control voltage from the vector control unit 23, the conversion unit 24 supplies control signals corresponding to the first control voltage, the second control voltage, and the third control voltage to the switching element group SWG1, the switching element group SWG2, and the switching element group SWG3.

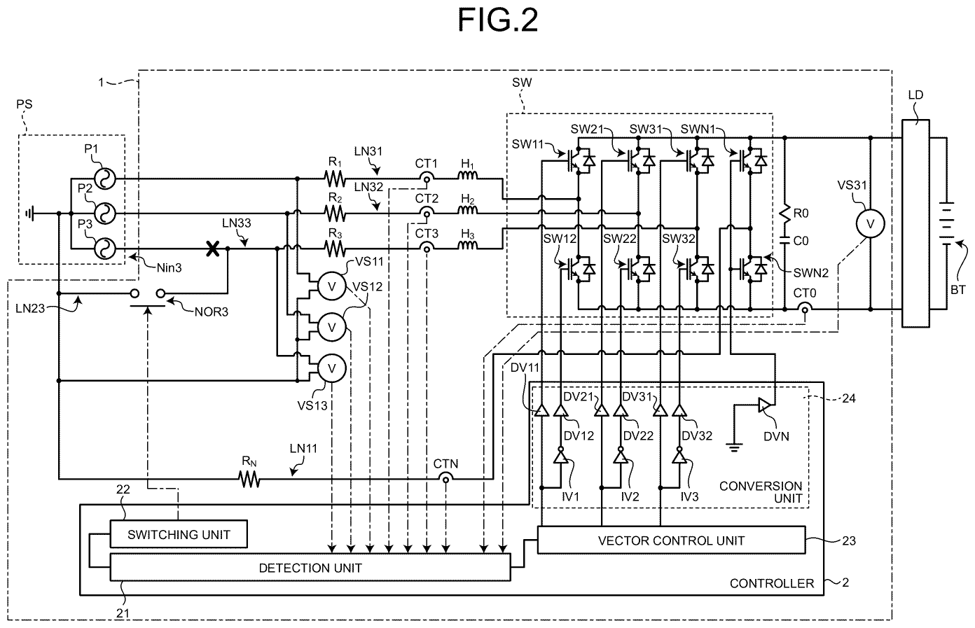

For example, when the effective value of the voltage detected by the voltage detector VS13 is equal to or less than the threshold value TH1, the detection unit 21 detects the disconnection of the line LN33 in the phase L3. The threshold value TH1 can be experimentally determined in advance as an effective voltage value indicating disconnection of the line. When the disconnection of the line LN33 in the L3 phase is detected, the detection unit 21 generates a detection result indicating the disconnection of the line LN33 and supplies the detection result to the switching unit 22 and the vector control unit 23. As illustrated in FIG. 2, the switching unit 22 selectively shifts the relay NOR3 corresponding to the phase L3 to the ON state. FIG. 2 is a diagram illustrating a change in the connection configuration at the time of disconnection of the charging device 1, and illustrates a case where the line LN33 in the phase L3 is disconnected near the node Nin3. In FIG. 2, the disconnection portion is indicated by a cross mark. The disconnection portion may be, for example, a portion between the exterior of the housing (not illustrated) of the charging device 1 and the AC power supply PS. Further, in FIG. 2, for the sake of simplicity, illustration of the relays NOR1 and NOR2 and the lines LN21 and LN22 is omitted.

When the relay NOR3 shifts to the ON state, the inductive element H3 on the line LN33 in the phase L3 is bypass-connected to the line LN11 via the line L23. The switching unit 22 keeps the relays NOR1 and NOR2 in the OFF state. The power of the phase L1 is supplied to the switching circuit SW through the line LN31 in the phase L1, and the power of the phase L2 is supplied to the switching circuit SW through the line LN32 in the phase L2. As a result, electromagnetic energy is stored and released in the inductive elements H1 and H2 corresponding to the phase L1 and the phase L2. At the same time, the vector control unit 23 performs vector control using the power of the phase L1 and the phase L2, and generates the first control voltage, the second control voltage, and the third control voltage. The conversion unit 24 converts the first control voltage, the second control voltage, and the third control voltage into switching control signals. The conversion unit 24 supplies the switching control signal to the switching element group SWG1, the switching element group SWG2, and the switching element group SWG3.

At this time, it is usable power of the phases L1 and L2 that is to be supplied to the switching circuit SW, but since the unusable inductive element H3 of the phase L3 is bypass-connected to the line LN11, a three-phase voltages V_{L1}, V_{L2}, and V_{L3} can be generated by the switching operations of the switching element groups SWG1, SWG2, and SWG3 of the phases L1, L2, and L3. As a result, the output DC voltage V_{VSN} can be stably generated.

The vector control unit 23 performs vector control using the power of phase L1 and the power of phase L2, and controls a voltage vector according to the power of phase L1 and the power of L2. The vector control unit 23 generates a command voltage V_{L1}*, a command voltage V_{L2}*, and a command voltage V_{L3}* according to the voltage vector. The controller 2 controls the switching element group SWG1, the switching element group SWG2, and the switching element group SWG3 using the command voltage V_{L1}*, the command voltage V_{L2}*, and the command voltage V_{L3}*.

The vector control unit 23 converts the current I_{L1} according to the power of phase L1, the current I_{L2} according to the power of phase L2, and the current I_{L3} according to the power of phase L3 into a d-axis current Id and a q-axis current Iq. The controller 2 generates a d-axis command voltage Vd* according to the d-axis current and a q-axis command voltage Vq* according to the q-axis current while bringing the value of the d-axis current Id closer to the value of the d-phase command current Id* and bringing the value of the q-axis current Iq closer to the value of the q-phase command current Iq*. The controller 2 converts the d-axis command voltage Vd* and the q-axis command voltage Vq* into the command voltage V_{L1}* of the phase L1, the command voltage V_{L2}* of the phase L2, and the command voltage V_{L3}* of the phase L3.

The conversion unit 24 generates switching control signals ϕSW11, ϕSW21, ϕSW31, ϕSW12, ϕSW22, and ϕSW32 according to the command voltage V_{L1}*, the command voltage V_{L2}*, and the command voltage V_{L3}*. The conversion unit 24 supplies the switching control signals ϕSW11, ϕSW21, and ϕSW31 to the control terminals of the switching element SW11, the switching element SW21, and the switching element SW31, respectively. The conversion unit 24 supplies the switching control signals ϕSW12, ϕSW22, and ϕSW32 to the control terminals of the switching element SW12, the switching element SW22, and the switching element SW32, respectively. As a result, switching operations of the switching element groups SWG1, SWG2, and SWG3 of the phase L1, the phase L2, and the phase L3 can be performed.

Note that the switching element group SWGN of the phase N is kept stopped. The conversion unit 24 generates the switching control signals ϕSWN1 and ϕSWN2 of a non-active level, and supplies these generated switching control signals to the control terminals of the switching element SWN1 and the switching element SWN2, respectively.

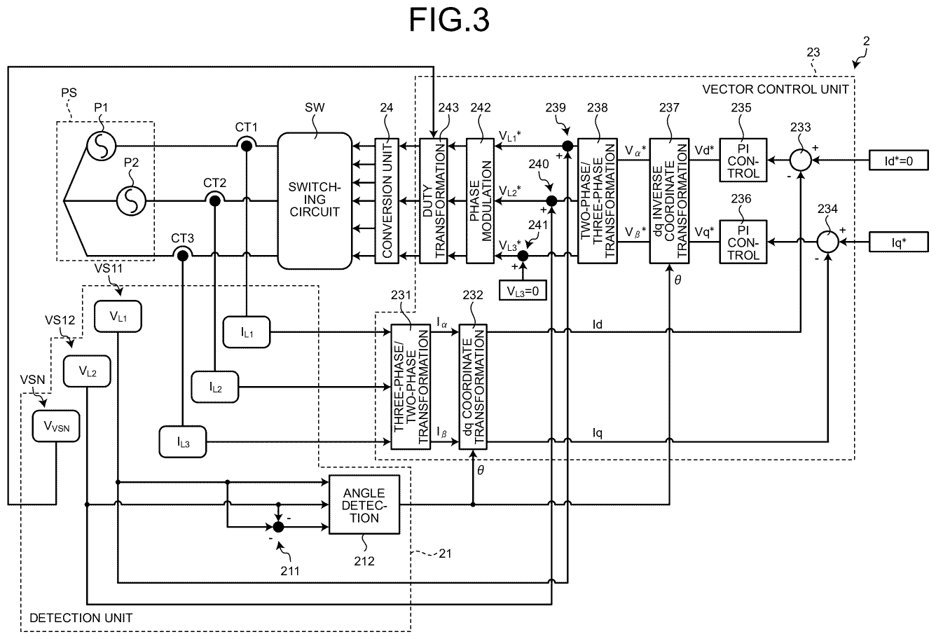

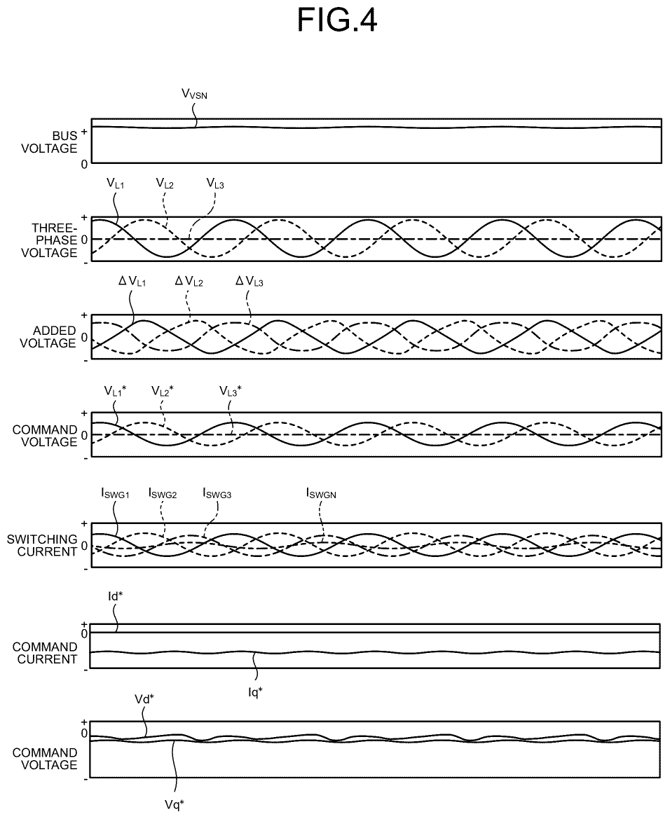

Regarding the vector control, the controller 2 may perform an operation as illustrated in FIG. 4 by the configuration illustrated in FIG. 3. FIG. 3 is a diagram illustrating a configuration of the controller 2. FIG. 3 illustrates a configuration in a case where disconnection of the line LN33 of the phase L3 is detected. FIG. 4 is a waveform diagram illustrating an operation of the controller 2.

In the vector control, the current vector is captured in a α-β fixed coordinate system and then coordinate-transformed into a d-q rotating coordinate system, and the d-axis current and the q-axis current are separated.

In the present embodiment, the vector control is applied to charge control by the charging device 1.

First, in the vector control, the feedforward control at the dq-axis voltage generated by the input voltage is performed after being converted into the three-phase voltage to correspond not to uniformity but to non-uniformity of the three phases. This makes it possible to correspond to a non-uniform input voltage. When the disconnection occurs at the line connected to the phase L3 outside the housing, the phase L3 is bypass-connected to the line LN11 of the phase N by the relay NOR3, and vector control is performed such that a uniform current flows in the phase L1, the phase L2, and the phase L3. The currents in the phase L1 and the phase L2 may be sinusoidal, for example. Accordingly, a high power factor can be realized. At this time, since no voltage is input in the phase L3, it is considered that the power factor is not affected.

The detection unit 21 illustrated in FIG. 3 includes an adder 211 and an angle detector 212. The vector control unit 23 includes a three-phase/two-phase transformation unit 231, a dq coordinate transformation unit 232, a subtractor 233, a subtractor 234, a PI control unit 235, a PI control unit 236, a dq inverse coordinate transformation unit 237, a two-phase/three-phase transformation unit 238, an adder 239, an adder 240, an adder 241, a phase modulation unit 242, and a duty transformation unit 243.

The detection unit 21 supplies the current IL1 detected by the current detector CT1 to the three-phase/two-phase transformation unit 231. The detection unit 21 supplies the current I_{L2} detected by the current detector CT2 to the three-phase/two-phase transformation unit 231. The detection unit 21 supplies the current I_{L3} detected by the current detector CT3 to the three-phase/two-phase transformation unit 231.

The detection unit 21 supplies the voltage V_{L1} detected by the voltage detector VS11 to each of the adder 211, the angle detector 212, and the adder 239. The detection unit 21 supplies the voltage V_{L2} detected by the voltage detector VS12 to each of the adder 211, the angle detector 212, and the adder 240. The detection unit 21 supplies the bus voltage V_{VSN} detected by the voltage detector VSN to the duty transformation unit 243. As illustrated in FIG. 4, the voltage V_{L1} and the voltage V_{L2} may have a sinusoidal waveform with a phase shifted by about 120°. The bus voltage V_{VSN} may be a waveform maintained at a substantially constant positive value.

The adder 211 illustrated in FIG. 3 adds the negative-phase voltage of the voltage V_{L1} and the negative-phase voltage of the voltage V_{L2}, and supplies a voltage (−V_{L1}-V_{L2}) as an addition result to the angle detector 212. The angle detector 212 obtains the rotation angle θ of the d-q rotating coordinate system with respect to the α-β fixed coordinate system using the voltage V_{L1}, the voltage V_{L2}, and the voltage −V_{L1}-V_{L2}. The angle detector 212 supplies the rotation angle θ to the dq coordinate transformation unit 232 and the dq inverse coordinate transformation unit 237.

The three-phase/two-phase transformation unit 231 performs Clarke transformation to transform an L1-L2-L3 fixed coordinate system into the α-β fixed coordinate system. The three-phase/two-phase transformation unit 231 may transform the current I_{L1} of the phase L1, the current IL2 of the phase L2, and the current IL3 of the phase L3 into the current Iα of the phase α and the current Iβ of the phase β using the following Formulas 1 and 2. In Formulas 1 and 2, the direction from the power supply PS to the switching circuit SW is positive for each of the currents I_{L1}, I_{L2}, and I_{L3}.

$$I α = ( √ ( 2 / 3 ) ) \times ( - {I}_{L 1} + {I}_{L 2} / 2 + {I}_{L 3} / 2 ) \qquad Formula 1$$

$$I β = ( √ ( 2 / 3 ) ) ( - √ ( 3 ) / 2 ) \times {I}_{L 2} + ( √ ( 3 ) / 2 ) \times {I}_{L 3} ) \qquad Formula 2$$

The three-phase/two-phase transformation unit 231 supplies the current Iα of the phase α and the current Iβ of the phase β to the dq coordinate transformation unit 232.

The dq coordinate transformation unit 232 performs Park transformation to transform the α-β fixed coordinate system into the d-q rotating coordinate system. The dq coordinate transformation unit 232 may transform the current Iα of the phase α and the current Iβ of the phase β into a current Id of the phase d and a current Iq of the phase q using the following Formulas 3 and 4 according to the rotation angle θ.

$$Id = I α \times cos θ + I β \times sin θ \qquad Formula 3$$

$$Iq = - I α \times sin θ + I β \times cos θ \qquad Formula 4$$

The dq coordinate transformation unit 232 supplies the d-axis current Id to the subtractor 233 and supplies the q-axis current Iq to the subtractor 234.

The subtractor 233 subtracts the d-axis current Id from a d-axis command current Id*. The d-axis command current Id* may be substantially 0. The subtractor 233 supplies a d-axis current deviation to the PI control unit 235.

The subtractor 234 subtracts the q-axis current Iq from a q-axis command current Iq*. The subtractor 234 supplies the q-axis current deviation to the PI control unit 236.

The PI control unit 235 performs P control (proportional control) and I control (integral control) according to the d-axis current deviation, and generates the d-axis command voltage Vd*. The PI control unit 235 supplies the d-axis command voltage Vd* to the dq inverse coordinate transformation unit 237.

The PI control unit 236 performs P control (proportional control) and I control (integral control) according to the q-axis current deviation, and generates the q-axis command voltage Vq*. The PI control unit 236 supplies the q-axis command voltage Vq* to the dq inverse coordinate transformation unit 237.

That is, the PI control unit 235 and the PI control unit 236 perform PI control such that the d-axis current deviation approaches 0 and the q-axis current deviation approaches 0. The voltage vector in the d-q rotating coordinate system is controlled, and the power factor can be improved.

The dq inverse coordinate transformation unit 237 performs an inverse Park transformation to transform the d-q rotating coordinate system into the α-β fixed coordinate system. The dq inverse coordinate transformation unit 237 may transform the d-axis command voltage Vd* and the q-axis command voltage Vq* into an α-phase voltage command Vα* and a β-phase voltage command Vβ* according to the rotation angle θ by using the following Formulas 5 and 6.

$$V {α}^{⋆} = {Vd}^{⋆} \times cos θ - {Vq}^{⋆} \times sin θ \qquad Formula 5$$

$$V {β}^{⋆} = {Vd}^{⋆} \times sin θ + {Vq}^{⋆} \times cos θ \qquad Formula 6$$

The dq inverse coordinate transformation unit 237 supplies the α-phase voltage command Vα* and the β-phase voltage command Vβ* to the two-phase/three-phase transformation unit 238.

The two-phase/three-phase transformation unit 238 performs inverse Clarke transformation to transform the α-β fixed coordinate system into the L1-L2-L3 fixed coordinate system. The two-phase/three-phase transformation unit 238 may transfer the α-phase voltage command Vα* and the β-phase voltage command Vβ* into the added voltage ΔV_{L1} of the phase L1, the added voltage ΔV_{L2} of the phase L2, and the added voltage ΔV_{L3} of the phase L3. As illustrated in FIG. 4, the added voltage ΔV_{L1}, the added voltage ΔV_{L2}, and the added voltage ΔV_{L3} may have sinusoidal waveforms whose phases are shifted from each other by about 120°.

The two-phase/three-phase transformation unit 238 supplies the added voltage ΔV_{L1} to the adder 239, supplies the added voltage ΔV_{L2} to the adder 240, and supplies the added voltage ΔV_{L3} to the adder 241.

The adder 239 adds the added voltage ΔV_{L1} to the voltage V_{L1} of the phase L1. The adder 239 supplies the addition result to the phase modulation unit 242 as a voltage command V_{L1}* of the phase L1.

The adder 240 adds the added voltage ΔV_{L2} to the voltage V_{L2} of the phase L2. The adder 240 supplies the addition result to the phase modulation unit 242 as a voltage command V_{L2}* of the phase L2.

The vector control unit 23 generates the voltage V_{L3} of the phase L3 at a value of substantially 0 and supplies the voltage V_{L3} to the adder 241.

The adder 241 adds the added voltage ΔV_{L3} to the voltage V_{L3} of the phase L3. The adder 241 supplies the addition result to the phase modulation unit 242 as a voltage command V_{L3}* of the phase L3.

The phase modulation unit 242 phase-modulates the voltage command V_{L1}* of the phase L1, the voltage command V_{L2}* of the phase L2, and the voltage command V_{L3}* of the phase L3. The phase modulation may be, for example, processing of expanding a voltage utilization factor such as hip phase modulation or two-phase modulation. The phase modulation unit 242 supplies the voltage commands V_{L1}*, V_{L2}*, and V_{L3}* after the phase modulation to the duty transformation unit 243.

The duty transformation unit 243 performs PWM transformation on the voltage command V_{L1}* of the phase L1, the voltage command V_{L2}* of the phase L2, and the voltage command V_{L3}* of the phase L3 according to the bus voltage V_{VSN}, and generates a PWM signal Suit, a PWM signal S_{L2}*, and a PWM signal S_{L3}*. The duty transformation unit 243 supplies the PWM signal Suit, the PWM signal S_{L2}*, and the PWM signal S_{L3}* to the conversion unit 24.

The conversion unit 24 illustrated in FIG. 1 includes drivers DV11, DV12, DV21, DV22, DV31, DV32, DVN, and inverters IV1, IV2, and IV3.

The conversion unit 24 drives the PWM signal S_{L1}* of the phase L1 with the driver DV11 and supplies the PWM signal S_{L1}* of the phase L1 to the control terminal of the switching element SW11 as the switching control signal ϕSW11.

The conversion unit 24 logically inverts the PWM signal S_{L1}* of the phase L1 with the inverter IV1, drives the PWM signal S_{L1}* of the phase L1 with the driver DV12 and supplies the PWM signal Suit of the phase L1 to the control terminal of the switching element SW12 as the switching control signal ϕSW12.

The conversion unit 24 drives the PWM signal S_{L2}* of the phase L2 with the driver DV21 and supplies the PWM signal S_{L2}* of the phase L2 to the control terminal of the switching element SW21 as the switching control signal ϕSW21.

The conversion unit 24 logically inverts the PWM signal S_{L2}* of the phase L2 with the inverter IV2, drives the PWM signal S_{L2}* of the phase L2 with the driver DV22 and supplies the PWM signal S_{L2}* of the phase L2 to the control terminal of the switching element SW22 as the switching control signal ϕSW22.

The conversion unit 24 drives the PWM signal S_{L3}* of the phase L3 with the driver DV31 and supplies the PWM signal S_{L3}* of the phase L3 to the control terminal of the switching element SW31 as the switching control signal ϕSW31.

The conversion unit 24 logically inverts the PWM signal S_{L3}* of the phase L3 with the inverter IV3, drives the PWM signal S_{L3}* of the phase L3 with the driver DV32 and supplies the PWM signal S_{L3}* of the phase L3 to the control terminal of the switching element SW32 as the switching control signal ϕSW32.

In FIGS. 1 and 2, for the sake of simplicity, the configuration of the conversion unit 24 in a case where the control signals ϕSW11, SW21, and SW31 of the switching elements SW11, ϕSW21, and ϕSW31 of the upper arms and the control signals ϕSW12, SW22, and SW32 of the switching elements SW12, ϕSW22, and ϕSW32 of the lower arms are complementary signals is illustrated. In practice, the control signals ϕSW11, ϕSW21, and ϕSW31 and the control signals ϕSW12, ϕSW22, and ϕSW32 are each provided with a dead time maintained at a non-active level. In that case, a delay element and a logical operation element for generating a dead time are further added to the conversion unit 24.

The conversion unit 24 drives the ground potential with the driver DVN, supplies the ground potential as the switching control signal ϕSWN1 to the control terminal of the switching element SWN1, and supplies the ground potential as the switching control signal ϕSWN2 to the control terminal of the switching element SWN2. Both the switching element SWN1 and the switching element SWN2 are controlled to the OFF state.

As a result, the switching currents I_{SWG1}, I_{SWG2}, I_{SWG3}, and I_{SWGN} as illustrated in FIG. 4 flow through the switching element group SWG1, the switching element group SWG2, the switching element group SWG3, and the switching element group SWGN. As a result of the addition, DC power corresponding to the bus current I_{CT0} and the bus voltage V_{VSN} is supplied from the charging device 1 to the battery BT via the load circuit LD, and the battery BT is charged.

As described above, in the embodiment, in the charging device 1, when one of the three phases (phases L1, L2, and L3) cannot be used due to disconnection or the like, the controller 2 selectively shifts the relay NOR corresponding to the unusable single phase to the ON state. The controller 2 controls the switching element group SWG1, the switching element group SWG2, and the switching element group SWG3 in the switching circuit SW according to vector control using the power of two phases usable. At this time, since the inductive element H of the unusable single phase is bypass-connected to the line LN11, a three-phase voltage can be generated by the switching operation of the switching element group SWG of the three phases. As a result, the three-phase power conversion configuration and the usable two-phase power conversion configuration can be almost made common, and the usable two-phase AC power can be efficiently converted into DC power. Therefore, the charging device 1 can be made compact, and power conversion can be efficiently performed.

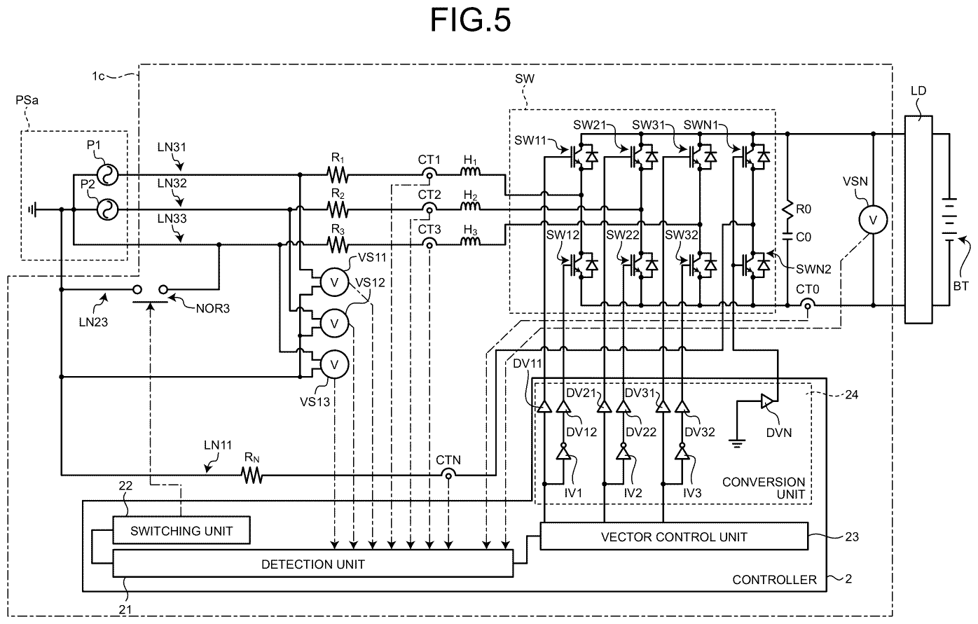

As a first modification of the embodiment, as illustrated in FIG. 5, a charging device 1c may be capable of performing an operation corresponding to connection of an AC power supply PSa that supplies two-phase AC power. FIG. 5 is a diagram illustrating a configuration of the charging device 1c according to the first modification of the embodiment.

The AC power supply PSa includes a power supply P1 and a power supply P2, and does not include a power supply P3. The power supply P1 generates power of the phase L1. The power supply P2 generates power of the phase L2. The AC power supply PSa may be, for example, a power system in a charging stand in a country where there is a chance of charging in two phases.

The charging device 1c is similar to the embodiment in that the input node Nin1 is connected to the power supply P1 and the input node Nin2 is connected to the power supply P2, but is different from the embodiment in that the input node Nin3 is connected to the reference potential (for example, the ground potential).

In the controller 2, the detection unit 21 detects that the AC power supply PSa is a power supply corresponding to two phases according to the voltage detection value of the voltage detector VS and the current detection value of the current detector CT. For example, when the effective value of the voltage detected by the voltage detector VS13 falls below the threshold value TH2, the detection unit 21 detects that the AC power supply PSa is a power supply corresponding to two phases (phases L1 and L2). The threshold value TH2 can be experimentally determined in advance as a voltage indicating that there is no power supply of the line. In a case where it is detected that the AC power supply PSa corresponds to two phases, the detection unit 21 generates a detection result indicating that the AC power supply PSa corresponds to two phases (phases L1 and L2), and supplies the detection result to the switching unit 22 and the vector control unit 23. Note that the line LN (in this case, the LN33) corresponding to single phase without a power supply is already connected to the line LN11 without operating the relay NOR, but this does not affect the basic operation of the charging device 1c. Hereinafter, the operation is substantially the same as that of the embodiment.

For example, the controller 2 selectively shifts the relay NOR corresponding to single phase having no power supply (in this case, the phase L3) to the ON state. The controller 2 controls the switching element group SWG1, the switching element group SWG2, and the switching element group SWG3 in the switching circuit SW according to vector control using the power of two phases having a power supply (in this case, the phases L1 and L2). At this time, since the inductive element H of the unusable single phase is bypass-connected to the line LN11, a three-phase voltage can be generated by the switching operation of the switching element group SWG of the three phases. In addition, the resistive element RN may be electrically inserted into the line LN11. The current detector CTN may be disposed at a position where the current around the line LN11 can be detected.

At this time, in the charging device 1c like this, in a case where the AC power supply PSa corresponds to two phases, since the inductive element H of the unusable single phase is bypass-connected to the line LN11, a three-phase voltage can be generated by the switching operation of the switching element group SWG of the three phases. As a result, the three-phase power conversion configuration and the usable two-phase power conversion configuration can be almost made common, and the usable two-phase AC power can be efficiently converted into DC power.

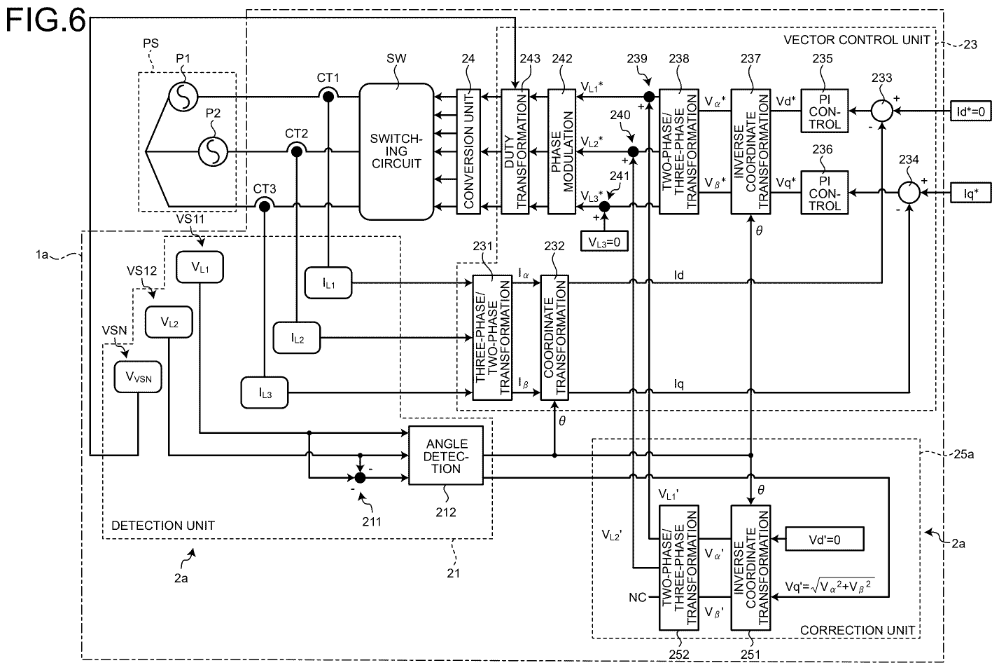

In addition, as a second modification of the embodiment, a charging device 1a may have a configuration for correcting a control error as illustrated in FIG. 6. FIG. 6 is a diagram illustrating a configuration of a controller 2a in the second modification of the embodiment.

In the charging device 1a, the controller 2a may further include a correction unit 25a. The correction unit 25a receives the voltage detection value of the voltage detector VS from the detection unit 21. The correction unit 25a advances the phase of the voltage detection value and generates a voltage V_{L1}′ of the phase L1 and a voltage V_{L2}′ of the phase L2 whose phases are advanced. The correction unit 25a supplies the voltage V_{L1}′ of the phase L1 and the voltage V_{L2}′ of the phase L2 whose phases are advanced to the vector control unit 23.

The correction unit 25a includes an inverse coordinate transformation unit 251 and a two-phase/three-phase transformation unit 252.

The correction unit 25a generates the d-axis voltage Vd′ to have a value of 0 and supplies the d-axis voltage Vd′ to the inverse coordinate transformation unit 251.

An angle detector 212 converts the voltage V_{L1} of the phase L1 and the voltage V_{L2} of the phase L2 from the voltage V_{L3} of the phase L3 (≈−V_{L1}−V_{L2}) to the voltage Vα of the phase α and the voltage Vβ of the phase β using the following Formulas 7 and 8.

$$V α = ( √ ( 2 / 3 ) ) \times ( {V}_{L 1} - {I}_{L 2} / 2 - {I}_{L 3} / 2 ) \qquad Formula 7$$

$$V β = ( √ ( 2 / 3 ) ) ( √ ( 3 ) / 2 ) \times {V}_{L 2} + ( √ ( 3 ) / 2 ) \times {V}_{L 3} ) \qquad Formula 8$$

The angle detector 212 may generate the adjusted q-axis voltage Vq′ by using the following Formula 9.

$${Vq}^{′} = √ ( V {α}^{2} + V {β}^{2} ) \qquad Formula 9$$

The angle detector 212 supplies the q-axis voltage Vq′ to the inverse coordinate transformation unit 251.

The inverse coordinate transformation unit 251 performs the inverse Park transformation to transform the d-q rotating coordinate system into the α-β fixed coordinate system. The inverse coordinate transformation unit 251 may transform the d-axis voltage Vd′ and the q-axis voltage Vq′ into the α-phase voltage Vα′ and the β-phase voltage Vβ′ according to the rotation angle θ by using the following Formulas 10 and 11.

$$V {α}^{′} = {Vd}^{′} \times cos θ - {Vq}^{′} \times sin θ \qquad Formula 10$$

$$V {β}^{′} = {Vd}^{′} \times sin θ + {Vq}^{′} \times cos θ \qquad Formula 11$$

The inverse coordinate transformation unit 251 supplies the α-phase voltage Vα′ and the β-phase voltage Vβ′ to the two-phase/three-phase transformation unit 252.

The two-phase/three-phase transformation unit 252 performs inverse Clarke transformation to transform the α-β fixed coordinate system into the L1-L2-13 fixed coordinate system. The two-phase/three-phase transformation unit 252 may transform the α-phase voltage Vα′ and the β-phase voltage Vβ′ into the voltage V_{L1}′ of the phase L1 and the voltage V_{L2}′ of the phase L2. The voltage V_{L1}′ and the voltage V_{L2}′ may be sinusoidal in waveform adjusted relative to the voltage V_{L1}, the voltage V_{L2}.

Note that the detection unit 21 does not supply the voltage V_{L1} detected by the voltage detector VS11 to the adder 239. The detection unit 21 does not supply the voltage V_{L2} detected by the voltage detector VS12 to the adder 240.

As described above, in the charging device 1a, the controller 2a performs vector control using the voltage V_{L1}′ of the phase L1 and the voltage V_{L2}′ of the phase L2 generated by the correction unit 25a. As a result, the control error in the controller 2a can be corrected.

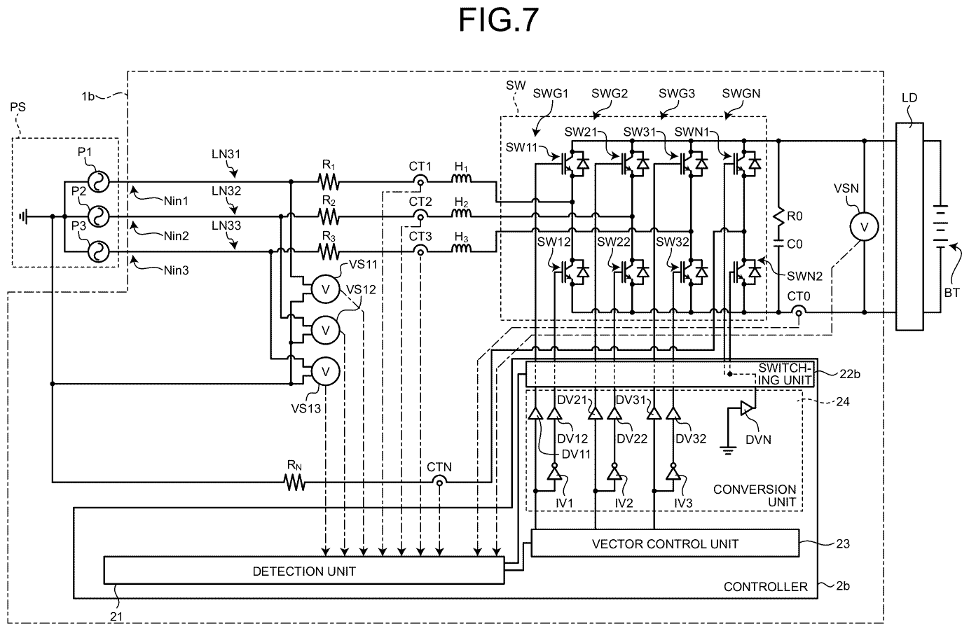

In addition, as a third modification of the embodiment, as illustrated in FIG. 7, a charging device 1b may be capable of switching controlling the switching element group SWGN of the phase N instead of the switching element group SWG of the unusable single phase in the switching circuit SW. FIG. 7 is a diagram illustrating a configuration of the charging device 1b according to the third modification of the embodiment. In addition, as in the embodiment (see FIGS. 1 and 2), the resistive element RN may be electrically inserted into the line LN11. The current detector CTN may be disposed at a position where the current around the line LN11 can be detected.

The charging device 1b includes a controller 2b instead of the controller 2 (see FIG. 1), and the relays NOR1, NOR2, and NOR3 are omitted. The controller 2b includes a switching unit 22b instead of the switching unit 22 (see FIG. 1). The switching unit 22b can switch a connection configuration between the switching element group SWG1, the switching element group SWG2, the switching element group SWG3, the switching element group SWGN, and the vector control unit 23 via the conversion unit 24. When receiving the detection result indicating the unusable single phase from the detection unit 21, the switching unit 22b causes the switching element group SWGN to be connected to the vector control unit 23 instead of the switching element group SWG corresponding to the unusable single phase.

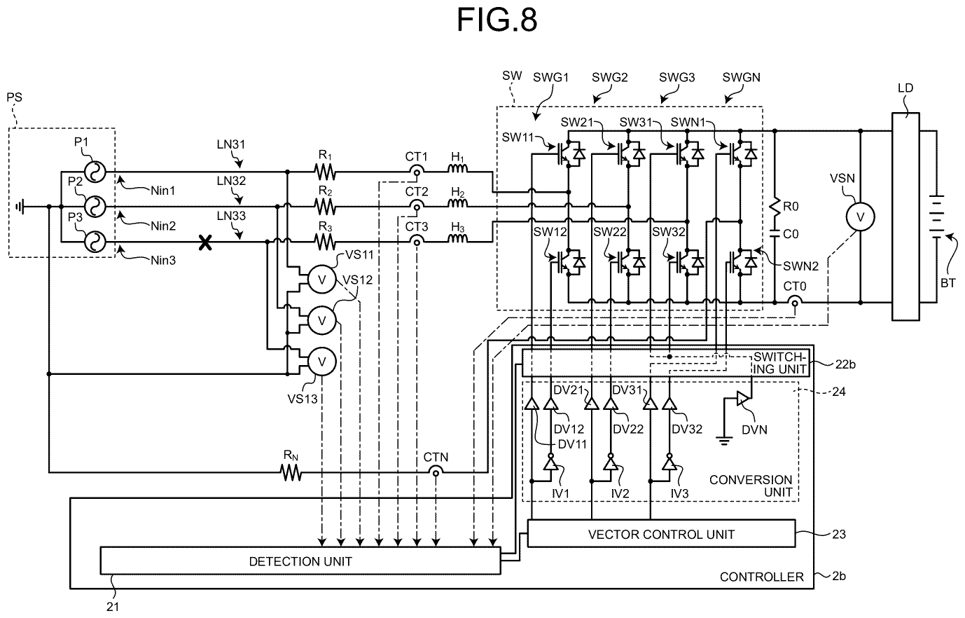

For example, when the disconnection of the line LN33 in the L3 phase is detected, the detection unit 21 generates a detection result indicating the disconnection of the line LN33 and supplies the detection result to the switching unit 22b and the vector control unit 23. As illustrated in FIG. 8, the switching unit 22b reconnects the switching element group SWG3 of the phase L3 to the driver DVN, and reconnects the N phase switching element group SWGN to the drivers DV31 and DV32. FIG. 8 is a diagram illustrating a change in the connection configuration at the time of disconnection of the charging device 1b according to the third modification of the embodiment, and illustrates a case where the line LN33 in the phase L3 is disconnected near the node Nin3. In FIG. 8, the disconnection portion is indicated by a cross mark. The disconnection portion may be, for example, a portion between the exterior of the housing (not illustrated) of the charging device 1b and the AC power supply PS.

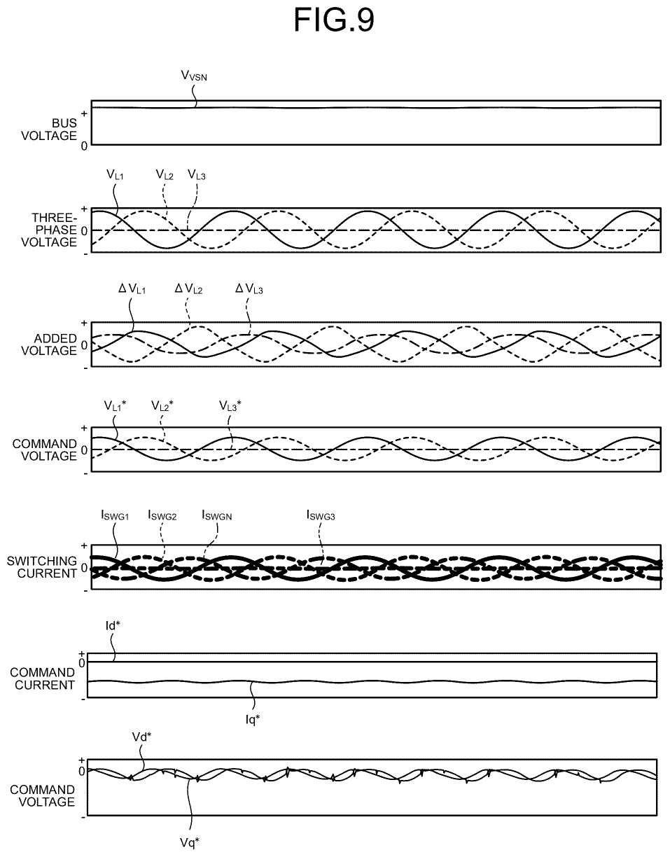

According to the detection result indicating the disconnection of the line LN33, the vector control unit 23 performs vector control as in the embodiment to generate the command voltage V_{L1}*, the command voltage V_{L2}*, and the command voltage V_{L3}* as illustrated in FIG. 9. FIG. 9 is a waveform chart illustrating an operation of the charging device 1b according to the third modification of the embodiment. The vector control unit 23 generates the PWM signal S_{L1}*, the PWM signal S_{L2}*, and the PWM signal S_{L3}* according to the command voltage V_{L1}*, the command voltage V_{L2}*, and the command voltage V_{L3}*, and supplies the PWM signal Suit, the PWM signal S_{L2}*, and the PWM signal S_{L3}* to the conversion unit 24.

The conversion unit 24 generates switching control signals ϕSW11, ϕSW12, SW21, ϕSW22, ϕSWN1, and ϕSWN2 according to the PWM signal S_{L1}*, the PWM signal S_{L2}*, and the PWM signal S_{L3}*. The conversion unit 24 supplies the switching control signals ϕSW11, ϕSW12, ϕSW21, ϕSW22, ϕSWN1, and ϕSWN2 to the switching elements SW11, SW12, SW21, SW22, SWN1, and SWN2, respectively. As a result, switching control of the switching element group SWGN of the phase N can be performed instead of the switching element group SWG3 of the unusable single phase.

As a result, the switching currents I_{SWG1}, I_{SWG2}, I_{SWG3}, and I_{SWGN} as illustrated in FIG. 9 flow through the switching element group SWG1, the switching element group SWG2, the switching element group SWG3, and the switching element group SWGN. As a result of the addition, DC power corresponding to the bus current I_{CT0} and the bus voltage V_{VSN} is supplied from the charging device 1b to the battery BT via the load circuit LD, and the battery BT is charged.

As described above, in the charging device 1b, since the N-phase switching element group SWGN is subjected to switching control instead of the unusable single-phase switching element group SWG, three-phase voltages can be generated by the switching operation of the switching element group SWG corresponding to three phases. As a result, the three-phase power conversion configuration and the usable two-phase power conversion configuration can be almost made common, and the usable two-phase AC power can be efficiently converted into DC power.

The charging device according to the present disclosure can efficiently convert AC power into DC power.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A charging device comprising:
a first input node;
a second input node;
a third input node;
a first switching element group corresponding to the first input node;
a second switching element group corresponding to the second input node;
a third switching element group corresponding to the third input node;
a first inductive element connected between the first input node and the first switching element group;
a second inductive element connected between the second input node and the second switching element group;
a third inductive element connected between the third input node and the third switching element group; and
a controller configured to control the first switching element group, the second switching element group, and the third switching element group according to vector control using a first phase power and a second phase power when receiving the first phase power at the first input node and receiving the second phase power at the second input node.

2. The charging device according to claim 1, wherein the controller is configured to, when receiving the first phase power at the first input node and receiving the second phase power at the second input node, control a voltage vector according to the first phase power and the second phase power, and control the first switching element group, the second switching element group, and the third switching element group by using a first control voltage, a second control voltage, and a third control voltage according to an adjusted voltage vector.

3. The charging device according to claim 1, wherein the controller is configured to, when receiving the first phase power at the first input node and receiving the second phase power at the second input node, convert a first phase current according to the first phase power and a second phase current according to the second phase power into a fourth phase current and a fifth phase current, convert a fourth control voltage according to the fourth phase current and a fifth control voltage according to the fifth phase current into a first control voltage, a second control voltage, and a third control voltage while bringing a value of the fourth phase current and a value of the fifth phase current closer to a first target value and a second target value, respectively, and control the first switching element group, the second switching element group and the third switching element group by using the first control voltage, the second control voltage, and the third control voltage.

4. The charging device according to claim 1, further comprising:
a fourth switching element group;
a first line connecting an input reference node and an intermediate node of the fourth switching element group; and
a second line connecting the first input node and a first node of the first inductive element to the first line.

5. The charging device according to claim 4, further comprising a relay inserted into the second line and being in an off state.

6. A charging device comprising:
a first input node;
a second input node;
a third input node;
a first switching element group corresponding to the first input node;
a second switching element group corresponding to the second input node;
a third switching element group corresponding to the third input node;
a fourth switching element group;
a reference line connecting an input reference node and an intermediate node of the fourth switching element group;
a first inductive element connected between the first input node and the first switching element group;
a second inductive element connected between the second input node and the second switching element group;
a third inductive element connected between the third input node and the third switching element group; and
a controller configured to control the first switching element group, the second switching element group, and the fourth switching element group according to vector control using a first phase power and a second phase power when receiving the first phase power at the first input node and receiving the second phase power at the second input node.

7. The charging device according to claim 6, wherein
the controller is configured to, when receiving the first phase power at the first input node and receiving the second phase power at the second input node, control a first control voltage for the first phase power, a second control voltage for the second phase power, and a third control voltage for the third phase power according to vector control using a first phase power and a second phase power and control the first switching element group, the second switching element group, and the fourth switching element group by using the first control voltage, the second control voltage, and the third control voltage.

8. A charging method in a charging device including: a first input node; a second input node; a third input node; a first switching element group corresponding to the first input node; a second switching element group corresponding to the second input node; a third switching element group corresponding to the third input node; a first inductive element connected between the first input node and the first switching element group; a second inductive element connected between the second input node and the second switching element group; and a third inductive element connected between the third input node and the third switching element group, the charging method comprising:
receiving a first phase power at the first input node and receiving a second phase power at the second input node;
controlling a first control voltage for the first phase power, a second control voltage for the second phase power, and a third control voltage for a third phase power according to vector control using the first phase power and the second phase power; and
controlling the first switching element group, the second switching element group, and the third switching element group using the first control voltage, the second control voltage, and the third control voltage.
